(19) United States
(12) Patent Application Publication
(10) Pub. No.: US 2013/0055313 A1
(43) Pub. Date: Feb. 28, 2013

(54) METHOD, COMPUTER PROGRAM, RECEPTION APPARATUS, AND INFORMATION PROVIDING APPARATUS FOR ACCESSING CONTENT FROM A PLURALITY OF CONTENT SOURCES

(71) Applicant: Mark EYER, Woodinville, WA (US)

(72) Inventor: Mark EYER, Woodinville, WA (US)

(73) Assignee: Sony Corporation, Tokyo (JP)

(21) Appl. No.: 13/562,946

(22) Filed: Jul. 31, 2012

Related U.S. Application Data
(60) Provisional application No. 61/529,484, filed on Aug. 31, 2011.

(51) Int. Cl. H04N 21/482

(52) U.S. Cl. 725/49

(57) ABSTRACT

A method, computer program, reception apparatus, and information providing apparatus for providing one or more virtual channel tables corresponding to one or more content sources. The reception apparatus includes an input unit and a processor. The input unit receives a channel selection from a user. The processor determines a source of content associated with the channel selection based on at least one virtual channel table stored in a memory. Based on the determined source of content, the processor controls a first communication interface to receive first content or a second communication interface to receive second content. The processor controls the first communication interface to receive the first content when the selected channel is determined to be associated with a first source, and controls the second communication interface to receive the second content when the selected channel is determined to be associated with a second source.

### CROSS-REFERENCE TO RELATED APPLICATION

This application is related to and claims priority under 35 U.S.C. §119(e) to U.S. provisional patent application No. 61/529,484, filed Aug. 31, 2011, which is incorporated herein by reference in its entirety.

### BACKGROUND OF THE INVENTION

1. Field of the Invention

Embodiments described herein relate generally to a method, computer program, and reception apparatus for accessing content. More particularly, the embodiments described herein relate generally to a navigational scheme for accessing content from a plurality of content sources.

2. Background

Recently, some broadcasters have expressed the desire to be able to include “widgets” that would be displayed on certain Internet-enhanced televisions. When activated, the widgets would take a user to that broadcaster's Internet-sourced content. However, widgets take up screen real estate whenever they are available to be activated, and thus may be considered cumbersome to, or unwanted by, a general user. Widgets also involve overt user action to make them visible and useful. Accordingly, there exists a need that would allow a user to access the content that would be provided from these widgets in a more streamlined and simpler method.

### SUMMARY OF THE INVENTION

According to an embodiment of the present invention, there is provided a method of a reception apparatus for accessing content from a plurality of content sources. The method includes receiving a channel selection from a user and determining a source of content associated with the selected channel based on at least one virtual channel table stored in a memory of the reception apparatus. The method further includes receiving first content via a first communication interface when the selected channel is determined to be associated with a first source, and receiving second content via a second communication interface when the selected channel is determined to be associated with a second source.

Further, according to an embodiment of the present invention, there is provided a computer-readable storage medium having instructions embedded therein, which, when executed by a computer, cause the computer to perform the method of the reception apparatus, as discussed above.

According to an embodiment of the present invention, there is provided a reception apparatus. The reception apparatus includes an input unit and a processor. The input unit receives a channel selection from a user. The processor determines a source of content associated with the channel selection based on at least one virtual channel table stored in a memory. Based on the determined source of content, the processor controls a first communication interface to receive first content or a second communication interface to receive second content. The processor controls the first communication interface to receive the first content when the selected channel is determined to be associated with a first source, and controls the second communication interface to receive the second content when the selected channel is determined to be associated with a second source.

Further, according to an embodiment of the present invention, there is provided an information providing apparatus. The information providing apparatus includes a memory and a communication unit. The memory is configured to store a triggered declarative object (TDO) that identifies a location of first content to be received by a reception apparatus via a first communication interface. Further, the communication unit is configured to provide the TDO to the reception apparatus. The TDO is also associated with second content to be received by the reception apparatus via a second communication interface; and

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 shows the data flow amongst the components of an exemplary broadcast system.

FIG. 2 is a block diagram of an exemplary reception apparatus.

FIG. 3 is a flow chart of a process for adding a virtual channel to a virtual channel table in one embodiment of the present invention.

FIGS. 4A-4D illustrates exemplary screenshots for adding the virtual channel to the virtual channel table.

FIG. 5 shows the data flow to and the data flow from the first and second virtual channel tables.

FIG. 6 is a block diagram of an exemplary information providing apparatus.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

In telecommunications, a virtual channel is a channel designation which may differ from the actual channel or frequency on which a signal travels over a transport stream. The term is often applied in the television environment, where several Digital Television (DTV) channels may be present within a single 6 MHz physical channel. For example, a station branded as Channel 8 might actually use RF channel 32 for its transmitted signal, but a virtual channel table (VCT) allows viewers to “tune in” the station on channel 8 on a digital television. The virtual channel entry in the VCT thus enables viewers to select the station by choosing the same channel number as they would have prior to the transition to digital broadcasting. The VCT accomplishes this by using defined parameters to link a channel number to content received from a terrestrial broadcast, cable television transmission, satellite broadcast, etc. These defined parameters may include the major channel number, minor channel number, short name, service type, descriptor, etc. In one embodiment, the VCT is in accordance with the Advanced Television Systems Committee (ATSC) VCT defined by ATSC A/65, which is incorporated herein by reference in its entirety.

While the channel numbers assigned to content received from the terrestrial broadcast, cable television transmission, satellite broadcast, etc., are typically fixed, embodiments of the present invention involve repurposing the unassigned channel numbers to access one or more different content sources. For example, in an ATSC digital television system, available programming channels are signaled by a VCT transmitted in a digital signal. The VCT links a channel number (major-minor, two-part) to broadcast content in an MPEG-2 transport stream. Embodiments of the present invention extend this concept to allow a broadcaster to identify another source of available content. For example, in the case of Internet-sourced content, a server's URL for that content is associated with an entry in the VCT so that the user can navigate to this source like he or she can to any other channel.

It should be noted that a virtual channel corresponding to Internet-sourced content can include metadata such as channel descriptions and program guide data, just like any other television channel. In some embodiments, the channel is associated with electronic program guide data delivered via the A/65 Event Information Table (EIT), an Extended Text Table (ETT), or other means. The virtual channel and a channel name may even be added to the electronic program guide without description information.

Thus, embodiments of the present invention avoid the cumbersome “widget” method and integrate access to other sources of content directly into, for example, the fundamental navigation paradigm of digital television (DTV) receiver by way of the VCT. For example, a user may be asked once whether they would like to add a virtual channel for a broadcaster's Internet-delivered service. If the user agrees, this virtual channel becomes available in the regular channel-number based navigational scheme.

In one embodiment, the one or more different content sources are accessed via one or more different communication interfaces. The one or more different communication interfaces may correspond to any of an interface to a local area network (LAN), wide area network (WAN), wireless local area network (WLAN), the Internet, additional tuners, other consumer electronic devices (e.g., a Blu-ray™ DVD player), or the like.

By repurposing unassigned channels to access other content sources, in one embodiment, a user of a reception apparatus such as a television set or set top box, can conveniently access content such as Internet content (e.g., a website, streaming a/v content, etc.), a Blu-ray™ DVD player, gaming machine, or any other content source simply by entering, or otherwise selecting, a channel number. Thus, a user would not be required to perform additional operations such as switching to a corresponding input source and navigating to a website, or selecting a bookmark to access content on a network.

Content that is received by the reception apparatus via the Internet rather than an MVPD (cable, satellite, or IPTV box), is sometimes referred to as “over-the-top” (OTT) video. The information defining such an OTT service may be downloaded from the Internet, or it may be derived from metadata delivered in a content transmission stream, as further discussed below. OTT video could include local news broadcast streams, financial data reporting, emergency alert updates, etc.

In one embodiment, the OTT content concept may be combined with the Triggered Declarative Object (TDO) mechanism being developed for a project known as “ATSC 2.0.” A TDO may be designed that can offer the user the opportunity to add this kind of virtual channel to a navigational scheme. The associated metadata would provide all the information a regular virtual channel provides, such as short channel name (7 characters), long name (optional), channel description (optional), and major and minor channel numbers.

A similar function can be offered from within the content offered by the broadcaster that is played on a web browser in the reception apparatus. After being directed to a web page of a broadcaster, a button can be offered that, if pressed, will result in the addition of a virtual channel into the user's television. This is like assigning a channel number to a browser bookmark.

One method for accessing this data from the reception apparatus, while viewing programming (e.g., television programming) from a content provider, is through the triggering of a TDO. A TDO is a downloadable software object created by a content creator or content provider. TDOs are typically delivered through the transport stream from the content provider and stored in memory until they are triggered. Generally, TDOs have declarative content (such as text, graphics, scripts, Internet links, and media) whose function and behavior is tied in some way to the television programming that it accompanies. When a TDO is triggered, either by an internal or external event, the data contained within is presented on the screen in some fashion. In an exemplary reception apparatus, the TDO may contain a suggestion or recommendation to the user about Internet-delivered content related to the currently viewed programming. The TDO may also contain metadata that will provide the necessary inputs needed to create an entry into a VCT that will correspond to suggested Internet-delivered content.

An embodiment of the TDO is described in U.S. application Ser. No. 12/959,529 filed Dec. 3, 2010 entitled “Announcement of Triggered Declarative Objects” to Blanchard et al. which is hereby incorporated by reference in its entirety. However, the TDO is not limited to the structure described in Blanchard et al. since many attributes defined therein as being a part of a TDO could be situated in a trigger or vice versa or not present at all depending upon the function and triggering of a particular TDO.

In one embodiment, since the initial VCT in a reception apparatus is typically used to define content received from a terrestrial broadcast, cable transmission, satellite broadcast, etc., a second table, which may be considered to be an extension or augmentation of the initial VCT, is used to store entries corresponding to content received via another source such as the Internet. The initial VCT used by the content provider, corresponding to processing of the standard digital television service, is hereinafter referred to as the first VCT. If a TDO is displayed that recommends or suggests Internet-delivered content that the user may be interested in, the user has the option to accept or deny the content of that TDO. If the user accepts the recommendation or suggestion of that TDO, the TDO will then add that content source to the second VCT using the provided metadata written in an appropriate representational language such as XML. In the case of XML data, the reception apparatus is programmed to add the XML data to its virtual channel table. This will result in the ability for the user to later select the content from the other source using a navigational scheme such as direct channel input, “channel surfing,” or by navigating an on-screen channel guide.

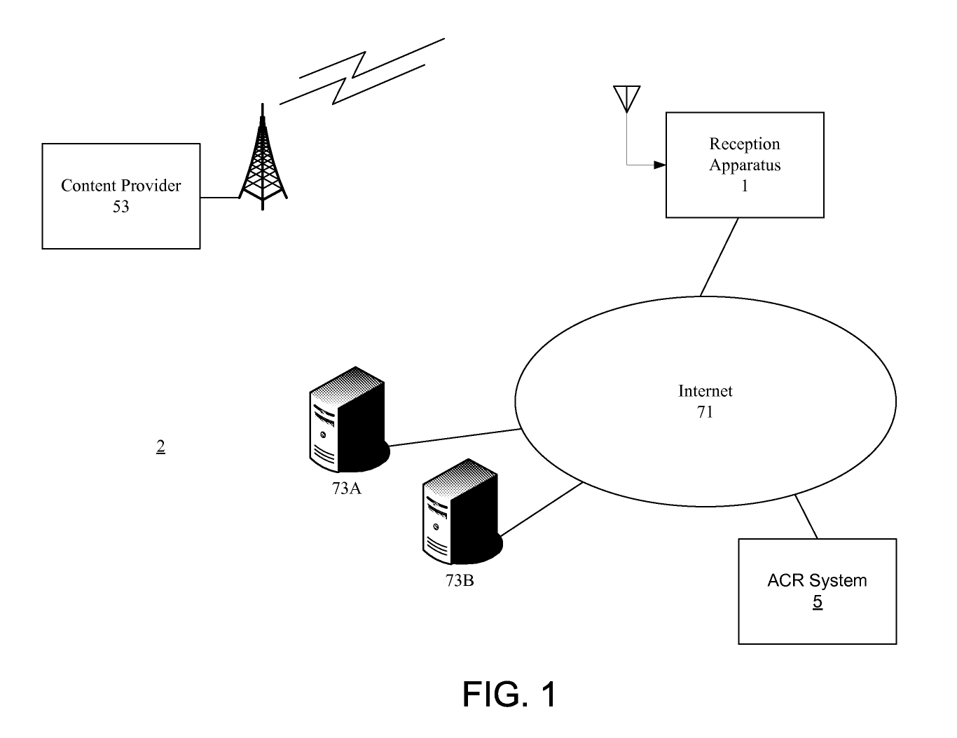

Referring now to the drawings, FIG. 1 is a block diagram that shows an exemplary broadcast system 2, including a content provider 53, a reception apparatus 1, and service providing servers 73A and 73B. The reception apparatus 1 accesses the service providing servers 73A and 73B via a communication network such as the Internet 71. In one embodiment, the content provider 53 includes a transmission apparatus with a transmitter that is configured to transmit first content to the reception apparatus 1. The first content is associated with a first channel defined in at least one virtual channel table, and is received by the reception apparatus 1 via a first communication interface. Further, the first content is optionally associated with second content received by the reception apparatus 1 via a second communication interface.

In one embodiment, the reception apparatus 1 is configured to receive content from the content provider 53 via a terrestrial broadcast. In other embodiments, the content provider 53 provides the content via at least one of a satellite broadcast, a cable television transmission, a terrestrial television broadcast, cellular network, and data communication network such as a local area network (LAN), wide area network (WAN), or the Internet 71.

The content provided by the content provider 53 includes one or more television programs, without regard to whether the content is a movie, sporting event, segment of a multi-part series, news broadcast, etc. Further, the content provided by the content provider 53 may also include advertisements, infomercials, and other program-like content which may not be reported as a program in an electronic program guide (EPG).

The reception apparatus 1 uses at least one VCT to tune to content provided by one or more content providers 53. In one embodiment, the reception apparatus 1 is configured to recognize and process opportunities that allow a user to add content for a virtual channel to a second VCT. When an opportunity is processed by the reception apparatus 1, the user may be asked whether they would like to add a virtual channel for a particular broadcaster's Internet-delivered content. If the user accepts this opportunity, the virtual channel will be added to the second VCT by the reception apparatus 1. After the channel has been added to the second VCT, the user can access the added Internet-delivered content in a manner similar to accessing the content provided from the content provider 53.

In one embodiment, the reception apparatus 1 is configured to allow the user to browse the Internet 71 through a network interface. From the browser, the user is directed to the website of the content provider 53 or various other entities, such as other content or service providers. When the user arrives at the website, the website may provide options to the user to allow the user to add Internet-delivered content to the second VCT. After the channel has been added to the second VCT, the user can access the added Internet-delivered content in a manner similar to accessing the content provided from the content provider 53.

The reception apparatus 1, in one embodiment, is also configured to allow the user to add custom Internet-delivered content with the metadata being provided by the user. The reception apparatus 1 displays a menu on a display 41 that allows the user to enter certain fields for the virtual channel such as a short name, major channel number, minor channel number, and/or a URL of the Internet-delivered content. After the data has been entered by the user, the reception apparatus 1 formats the data into the appropriate format and representation and enters it into the second VCT. After the channel has been added to the second VCT, the user accesses the added Internet-delivered content in a manner similar to accessing the content provided from the content provider 53.

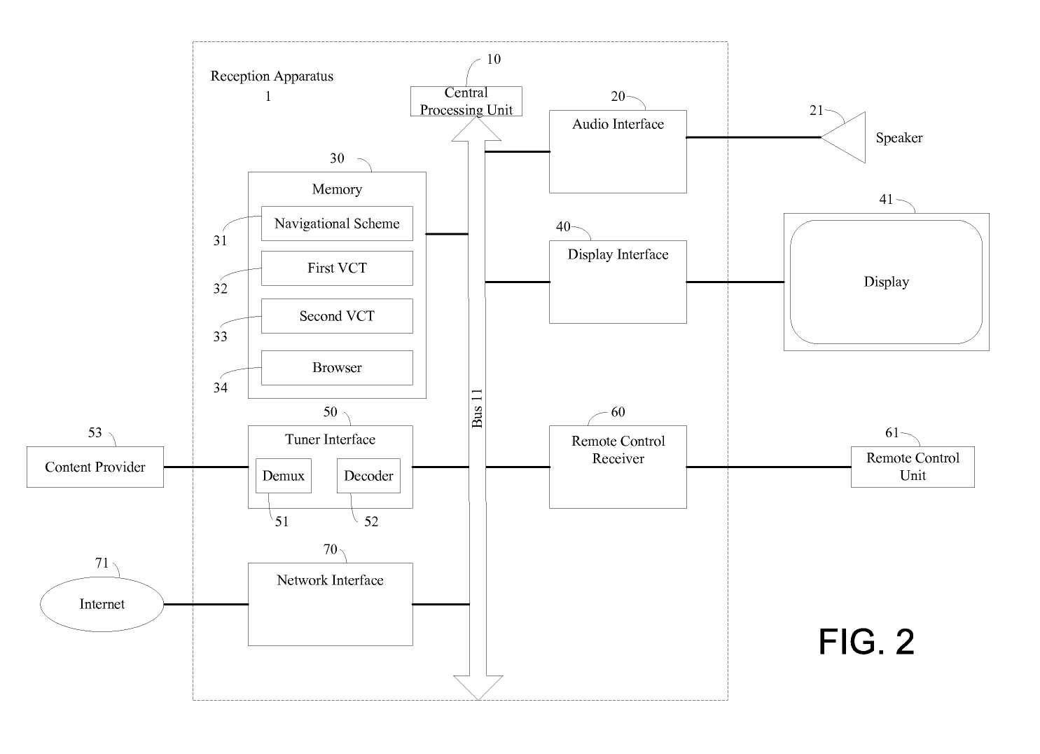

FIG. 2 is a block diagram of an exemplary reception apparatus 1 which can take on many forms including a television set, set-top box, etc. According to one embodiment, the reception apparatus 1 includes a central processing unit (CPU) 10, a memory 30, an audio interface 20, a display interface 40, a remote control receiver 60, a tuner interface 50 (e.g., a first communication interface), and a network interface 70 (e.g., a second communication interface).

Data is communicated via one or more buses 11. Audio and/or video streams that have been decoded by the tuner interface 50, as well as a TDO when delivered via the transport stream, are retrieved. The decoded audio stream is sent to the audio interface 20 and the decoded video stream is sent to the display interface 40. In one embodiment, the TDO may also, or alternatively, be retrieved via the Internet. The TDO's retrieved via the transport stream are stored in the memory 30. The CPU 10 also receives data from and sends data to the Internet 71 via the network interface 70. Further, the CPU 10 executes commands received by the remote control receiver 60. These commands can be in the form of a direct channel entry through the keypad of the remote control unit 61 or inputs from the remote control unit 61 using an on-screen channel guide.

The memory 30 stores the data used by the reception apparatus 1. The memory 30 within the reception apparatus 1 can be implemented using disc storage form as well as other forms of storage such as non-transitory storage devices including for example network memory devices, magnetic storage elements, magneto-optical storage elements, flash memory, core memory and/or other non-volatile storage technologies. Additionally, the memory 30 can provide for non-real time (NRT) or Internet-delivered content such as Internet Protocol Television (IPTV).

The memory stores a navigational scheme 31 which provides, for example, the on-screen channel guide or an electronic programming guide (EPG), that allows the user to select desired content accessible via one or more communication interfaces to content sources such as a television broadcast and the Internet. A first VCT provides a channel map for the CPU 10 to determine what content received by the tuner interface 50 corresponds to a user selected virtual channel entered via the remote control unit 61 or the navigational scheme 31. A second VCT provides a channel map for the CPU 10 to determine what Internet-delivered content corresponds to the user selected virtual channel entered via the remote control unit 61 or the navigational scheme 31.

The tuner interface 50 receives content provided through any suitable delivery source such as a terrestrial broadcast, cable transmission, satellite broadcast, or the Internet. The content is provided by one or more content providers. In one embodiment, the content is contained in a transport stream that includes one or more of channel data, first VCT data, TDO's, TDO triggers, etc. The transport stream is received at the tuner interface 50 and is demultiplexed at demultiplexer 51 into audio, video, and/or data streams. The audio and/or video streams are decoded at decoder 52 within the tuner interface 50. Data streams from the content provider 53 contain information such as VCT data corresponding to the channels provided by the content provider 53. This data provided by the content provider 53 is placed in the first VCT 32 within the reception apparatus memory 30 via the CPU 10.

The reception apparatus 1 generally operates under control of a processor such as CPU 10 which may be interconnected to any one or a combination of a memory 30, an audio interface 20, display interface 40, and remote control receiver 60 via one or more buses 11. When the transport stream is demultiplexed at the demultiplexer 51, audio and visual data are sent to the decoder for decoding and sent to the audio interface 20 and display interface 40, respectively. In addition to the audio and visual data, the demultiplexer also receives VCT data updated by the content provider 53 to the first VCT 32 in the memory 30. In one embodiment, the data in the first VCT 32 is then used to update the navigational scheme 31 available to the user with the respective content available from the transport stream provided by the content provider 53. In addition to the content available from the content provider 53, the user can also access the Internet 71 through a network interface 70 with Internet content being generated and displayed via a browser 34 or another appropriate application or player located in the memory 30.

An opportunity to add a virtual channel to the second virtual table 33 can come from numerous sources including, but not limited to, a trigger delivered within a transport stream to the tuner interface 50 that triggers the retrieval and execution of a TDO, an option provided via a website accessed via the network interface 70, or a user request received for example by the remote control receiver 60. In one embodiment, when the trigger is not available via the TS, the reception apparatus 20 acquires the trigger via an automatic content recognition (ACR) system 5 by, for example, sending A/V samples of the content being received by the reception apparatus 1 to the ACR system 5 illustrated in FIG. 1.

When the opportunity to add a virtual channel is presented, the CPU 10 will then alert the user that an opportunity is available and subsequently determine if the user wants to accept or deny the opportunity. Upon accepting the opportunity, the CPU 10 will acquire metadata based on the source of the opportunity and update the second VCT 33. The appropriate metadata is used to create a virtual channel entry, corresponding to the Internet-delivered content or other content source, within the second VCT.

When the user enters a channel number using the remote control unit 61 or selects a channel number via the navigational scheme 31, as presented on the display 41, the CPU 10 will receive the desired virtual channel number and access the first VCT 32 in order to determine if there is a corresponding entry. If a match is found, then the CPU 10 will instruct the tuner interface to tune to the selected physical transmission channel and present the content associated with the channel via the display interface 40 and audio interface 20, which are connected to the display 41 and a speaker 21, respectively. If a match is not found, the CPU 10 will then access the second VCT 33, containing Internet-delivered content, in order to determine if there is a corresponding entry. When a corresponding entry is found in the second VCT 33, the CPU 10 will cause the corresponding Internet-delivered programming to be sent to the display interface 40 and audio interface 20 for example via the browser 34. However, it should be noted that the first and the second VCTs need not be accessed in any particular order, and in one embodiment, may be combined in to a single VCT.

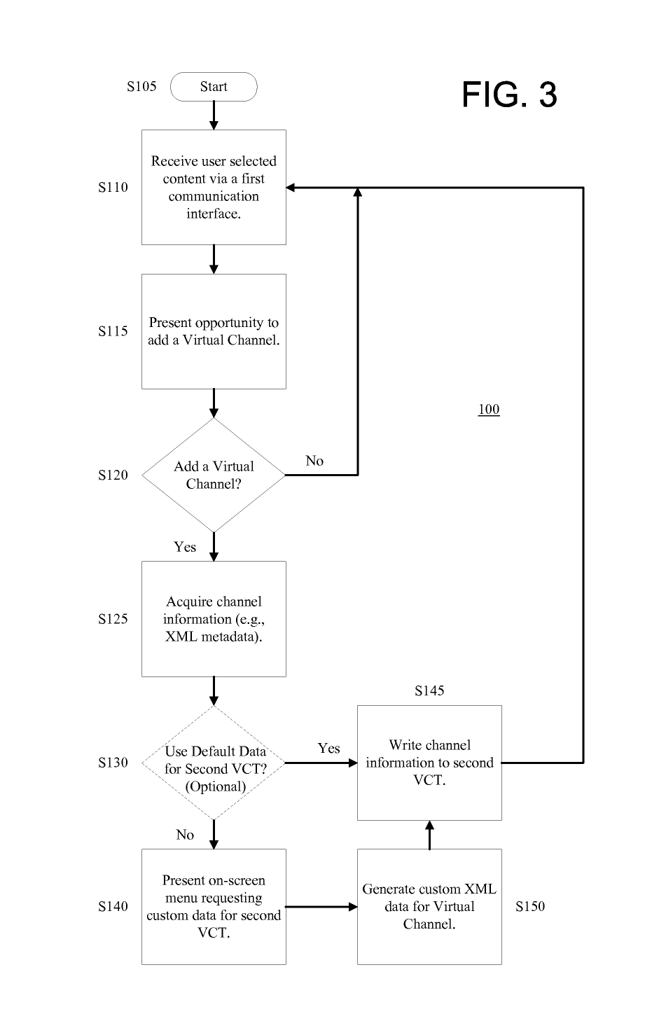

FIG. 3 is a basic flowchart 100 depicting an exemplary process carried out in a manner consistent with an embodiment of the present invention. Starting at step S105, a user will select content at step S110 that is provided to the reception apparatus 1 and viewed by the user using a display. At some point, an opportunity at step S115 may arise for the user to add a virtual channel corresponding to Internet-delivered content to the second VCT. However, it should be understood that content from other sources may be added in addition, or as an alternative, to the Internet-delivered content. This opportunity may be derived from, but is not limited to, the execution of a TDO, a website (e.g., a broadcaster or service provider's homepage), or initiation by the user to enter custom data.

If the user denies the opportunity at step S120 to add a virtual channel corresponding to Internet-delivered content, the user will be returned to their previously selected content with no changes to the second virtual table. If the user accepts the opportunity at step S120 to add a virtual channel corresponding to Internet-delivered content, the reception apparatus 1 will receive at step S125 the appropriate default metadata from the source of the opportunity that will be used to make an entry into the second VCT.

In one embodiment, the metadata is formatted as XML data, but can be formatted in any other representation appropriate for the application. When the reception apparatus 1 receives the default metadata from the opportunity, the reception apparatus 1 optionally asks at step S130 if the user would like to modify the default metadata by entering in custom data. The extent of the ability of the user to enter custom data can be regulated by the content provider or another entity so that only certain fields, such as the minor channel number field or the short name field, can be modified over the default metadata.

If the user does not want to enter custom data for the virtual channel corresponding to Internet-delivered content, the reception apparatus 1 will generate an appropriate VCT entry using the default metadata obtained from the source of the opportunity from step S125. The default metadata will then be written to the second VCT at step S145. If the user accepts the opportunity at step S130 to enter custom data for the virtual channel corresponding to the Internet-delivered content, the reception apparatus 1 will produce an on-screen menu at step S140 where the user can enter the custom data into appropriate fields as determined by the service provider. Once the custom data has been entered, the reception apparatus 1 will modify at step S150 the default metadata from the source of the opportunity based on the custom data entered by the user and generate the appropriate channel information to be entered into the second VCT.

Once the channel information has been generated, the custom data will then be written to the second VCT at step S145. This will allow the user to, from this point forward, access the Internet-delivered content by entering a corresponding channel number on the remote control unit 61 or by selecting the corresponding channel from the navigational scheme 31.

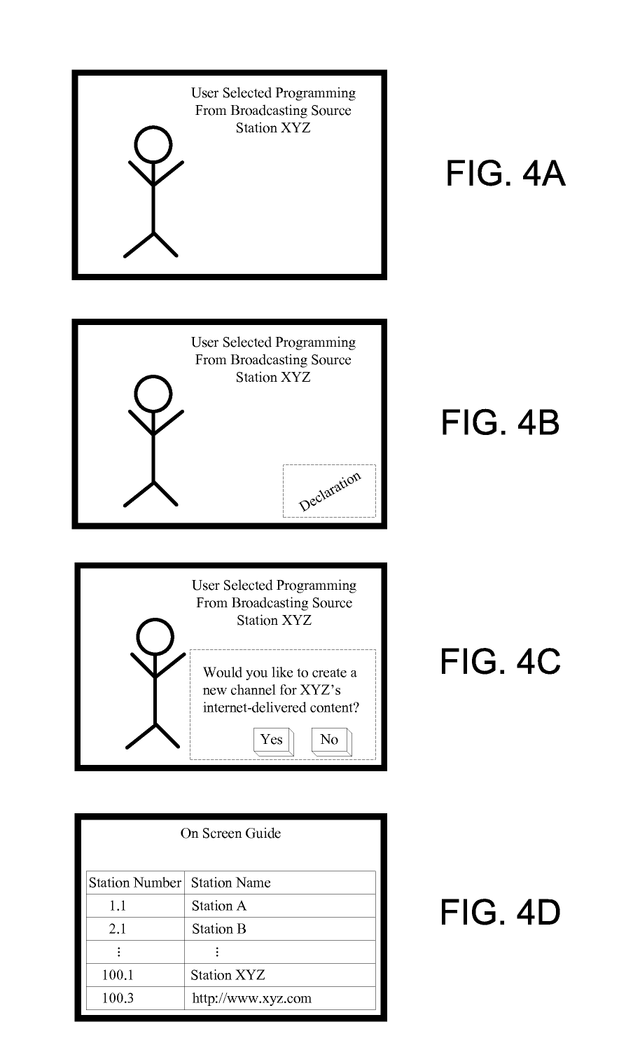

FIGS. 4A-4D depict exemplary screenshots for adding a virtual channel to content acquired via another content source through the use of a TDO. FIG. 4A shows an exemplary user selected broadcast content provided by the content provider 53. At some point, a TDO associated with the selected content is triggered, as shown in FIG. 4B. The TDO provides a recommendation or suggestion to the user that content (e.g., related content similar to that currently being displayed) is available via another communication interface such as the Internet 71. In this example the user may be watching channel XYZ being delivered in a digital format from the content provider 53. The alert or recommendation may indicate that associated content can be delivered or streamed from the Internet homepage of XYZ via the associated URL as shown in FIG. 4C. If the user decides to add the Internet-delivered content, the second VCT will be updated with appropriate metadata and can subsequently be accessed from an on-screen channel guide as shown in FIG. 4D. The on-screen channel guide of FIG. 4D illustrates that content provided by Station XYZ can be accessed by selecting channel 100.1 while the Internet-delivered data from the homepage of Station XYZ can be accessed by selecting channel 100.3. Either of these channels may be selected using the keypad on the remote control unit 61 or through the on-screen channel guide.

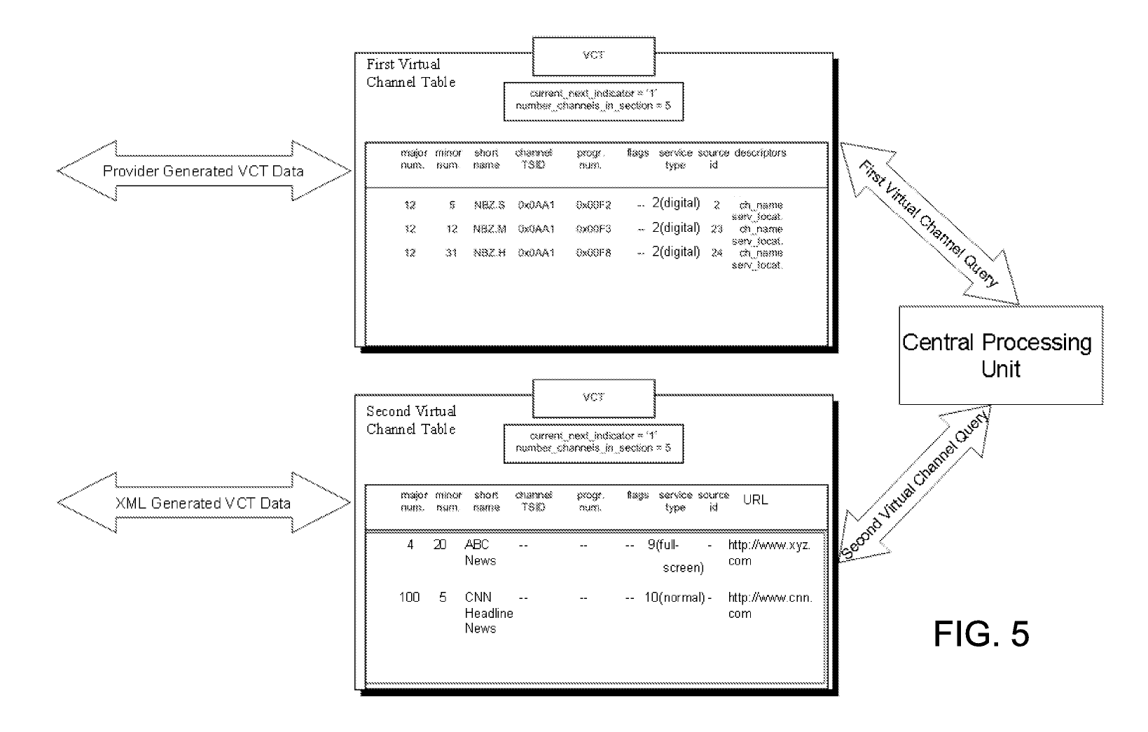

FIG. 5 graphically shows the flow of data to and from the first VCT and the second VCT as discussed above. Initially, the first VCT is populated with virtual channels corresponding to one or more content providers. In one embodiment, the virtual channel information is pulled from the transport stream and stored by the CPU 10. The second VCT is populated with user accepted opportunities from sources such as TDO's, websites, or manual user entry. For example, the entry into the second VCT may have been entered via a TDO or directly from a content provider or website. Further, in one embodiment XML metadata used to generate a virtual channel entry in the second VCT may have take the following form:

<?xml version=″1.0″ encoding=″UTF-8″?>
<OOTVideo xmlns=“http://www.atsc.org/XMLSchemas/ATSC2.0/
2012/1.0”>
<VCTEntry service_type=“9” major_channel_number=“4”
minor_channel_number=“20” short_name=“ABCnews”>
<location>http://abc.tv/3340/newsfeed.rm</location>
<description>ABC Newsfeed channel; 24-hour short news
clips.</description>
<capability>22</capability>
</VCTEntry>
</OOTVideo>

This XML metadata corresponds to an entry into the second VCT corresponding to a virtual channel called “ABCnews” with a channel number “4-20.” The above-noted XML metadata may be contained in an instance file that is received over the Internet as a downloaded file. Alternatively, the instance file may be delivered over a terrestrial broadcast as a file in the non-real-time content (NRT) using File Delivery over Unidirectional Transport (FLUTE) protocol. Other delivery methods are also possible.

The above-noted XML metadata also defines a service_type (e.g., service_type=“9”). The service_type, in one embodiment, refers to a parameter defined in the ATSC A/65 Program and System Information Protocol (PSIP), associated with each Virtual Channel. There are a half-dozen or so service types defined in the PSIP Virtual Channel Table (VCT), including

Service_type=2 (ATSC digital television—regular television service)

Service_type=3 (Audio only—radio service)

Service_type=4 (Data service)

Service_type=5 (Software download service)

Reception apparatuses offer the user the ability to select and tune to channels by way of the service_type and virtual channel number defined in the VCT. For example, processing the VCT in each Transport Stream multiplex (in each physical channel) is what allows the reception apparatus 1 to properly let the user navigate amongst the available channels. When the reception apparatus 1 encounters a VCT entry associated with an unrecognized service_type, it disregards that entry (e.g. does not let the user tune to that channel). Today's reception apparatuses typically disregard anything labeled with a service_type value other than 2 (or maybe 3, or sometimes 5).

In the above-noted XML metadata example, service_type 9 is used to define an Internet-sourced content service. Further, different service types can be used to designate different display modes for the Internet-sourced content. For example, as illustrated in FIG. 5, service_type 9 can be used to designate an Internet-sourced content service that is to be displayed in a full-screen mode and service_type 10 can be used to designate an Internet-sourced content service that is to be displayed in a normal mode (e.g., within a window). However, any other unused service_type numbers could be used to identify the Internet-sourced content with or without display modes. In other embodiments, an additional parameter can be used to designate the presentation (e.g., display) mode of the Internet-sourced content service or any other service type. For example, the additional parameter could be defined in the VCT entry or any other location such as the EPG.

In one embodiment, the XML instance file includes parameters that instruct a server where a user got the opportunity to add the virtual channel. The server may provide a different stream to the user based on the source of the opportunity.

In one embodiment, the reception apparatus 1 is configured to display content from Internet-delivered content in a windowed, framed, or full screen mode based on a mode designated by the Internet-delivered content, a user setting, a default setting defined in the second VCT, channel information associated with the Internet-delivered content, or the like. For example, the user could add a channel called ABC News to the second virtual channel table. The Internet-delivered content corresponding to the channel ABC News may be a web page associated with a particular URL and including desired content embedded therein. The content may simply be embedded in a portion of, and displayed along with, the web page in a windowed mode. Upon selecting the ABC News channel and accessing the URL, the user can perform an additional action to maximize the embedded content and display it in a full screen mode. In one embodiment, the user would have the option at the time of adding the Internet-delivered content to display the content via the windowed, framed, or full screen mode. If, upon receiving the request to add ABC News to the second virtual channel table, the user wants the Internet-delivered content to be presented in full screen, the reception apparatus 1 would select the appropriate option to be entered into the second virtual channel table.

FIG. 5 shows that the entry of full-screen is entered under the service type heading. The full-screen entry indicates that when ABC News is selected, the respective Internet-delivered content will be in presented in full screen. If the user later wants to add another channel to the second virtual channel table, such as CNN Headline news, but wants to maintain the Internet-delivered in a windowed mode, the user would select the appropriate option at the time of adding the Internet-delivered content to display the content in the windowed mode. FIG. 5 shows that the entry of normal is entered under the service type heading. The normal entry indicates that when CNN Headline News is selected, the respective Internet-delivered content will be presented in a window instead of full screen.

Alternatively, the reception apparatus 1 could enter the appropriate options based on the mode designated by the Internet-delivered content, the default setting in the second VCT, the channel information associated with the Internet-delivered content, or the like, instead of based on a user setting. Further, if the content is to be displayed in a framed mode, the display could zoom in to the portion of the web page in which the content is embedded.

Virtual channels also typically convey a “service type” which indicates to the reception apparatus 1 how content associated with the channel is expected to be processed and presented. In the case of ATSC broadcasts, the service type is typically of the ATSC “digital television” service type. Other service types include a code download service, audio only, and data broadcast. In one embodiment, service type codes convey the codecs that must be supported in the reception apparatus 2 to handle the content on that channel.

One aspect of the service type, as mentioned, is that it conveys the expected way the reception apparatus 1 is to present the content to the user for consumption. For an OTT video service type, for example “OTT full screen” can be defined such that the expected behavior in the reception apparatus 1 is to access a streaming audio and/or video service referenced by the channel's URL, and immediately begin consuming and decoding the audio and/or video, presenting the video using the full screen real estate. Compare this to the typical experience a user has visiting YouTube.com. First, a page containing many video thumbnails is presented. If one is chosen, a web page is displayed with that video in a larger window in the upper left area of the browser window. The user can begin playing the video from that window, or they can choose to go to “full screen” mode. Another related service type could be more like an initial home page view of a website, such as the view from YouTube.com's home page.

To implement an OTT (e.g., Internet delivered content) virtual channel concept, a new service type code is defined, perhaps called “Internet-Sourced Content,” as noted above In one embodiment, the reception apparatus 1 understands the service type code to mean that the service can be offered only if an Internet connection is available and active in the reception apparatus 1. In addition to the service type, other metadata may be supplied to indicate the types of content that will be present in the OTT virtual channel service. Such metadata could take the form of Internet Media Type strings (formerly known as MIME-types), or “capability code” bytes. The latter is a concept developed for ATSC's first NRT standard. Each capability code represents a codec profile, wrapper format, transport method, etc.

When a user selects a channel (e.g., using the navigational scheme 31), in this case the channel corresponding to “ABCnews,” the CPU 10 searches the first and/or second VCTs in order to determine the corresponding content source. The selection can also be made by entering “4-20” on the remote control unit 61. Note that in some implementations, the delimiter between the major and minor channel numbers may be a decimal point rather than a hyphen. Upon finding the entry for channel 4-20 on the navigational scheme 31, the reception apparatus 1 would tune to that content. Upon receiving the input from the remote control unit 61 or the navigational scheme 31, the CPU 10 looks for an appropriate entry in the first VCT. When there is no corresponding entry to channel 4-20 (corresponding to “ABCnews”) in the first VCT, the CPU 10 then looks for the appropriate entry in the second VCT. Upon finding the entry for channel 4-20 in the second VCT, the CPU 10 would select the corresponding Internet-delivered content to display on the display 41.

In one embodiment, the user receives the opportunity to add Internet-delivered content to the second VCT while using the reception apparatus 1 to browse the Internet 71 via the network interface 70. In a non-limiting example, if the user has accessed the homepage of a broadcaster or service provider that has Internet-delivered content available, the user can add one or more Internet-delivered content to the second VCT 33. This is accomplished when the CPU 10 sends the request for XML metadata to the broadcaster or service providers website and subsequently stores the metadata in the second VCT 33, for example as described above.

In another embodiment, the user manually enters the appropriate metadata into the second VCT if the data is already known by the user. For a non-limiting example, the reception apparatus 1 displays a menu on the display 41 which allows the user to enter certain fields such as a short name, major channel number, minor channel number, and/or the URL of content available using the network interface 70 such as Internet-delivered content. After the data has been entered by the user, the CPU 10 formats the data into an appropriate format and enters it into the second VCT 33. This allows the user to later select content received via the network interface 70 using a channel number, which functions in a similar manner as a browser bookmark.

According to one embodiment, the reception apparatus 1 is configured to remove entries in the VCT that are no longer desired. If the user would like to remove an entry from the VCT, one non-limiting example would be for the user to access a menu on an on-screen channel guide that will prompt the user to remove a selected virtual channel. When the removal of the entry from the VCT (e.g., the second VCT 33) has been accepted, the corresponding virtual channel information will be removed from or overwritten in the memory 30. After the channel has been removed from the VCT, the user can no longer access the content (e.g., Internet-delivered content) associated with that virtual channel. Alternatively, access to the virtual channel may be temporarily disabled or set to expire at a predetermined date and/or time.

In one embodiment, content received from different content sources, for example via difference communication interfaces, but associated with the same content provider are assigned the same major channel number. In another embodiment, the content received from the same communication interface may be assigned the same major channel number. Alternatively, the content received from different content sources can be assigned to channel numbers based on any other predetermined or user-selected criteria.

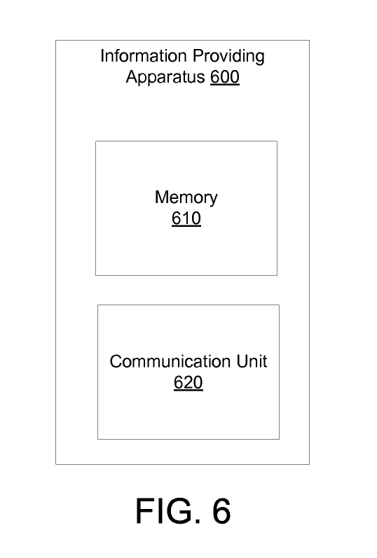

FIG. 6 illustrates an exemplary information providing apparatus 600, which may be included in the content provider 53, the ACR system 5, or a stand-alone device. As illustrated in FIG. 6, the information providing apparatus 600 includes a memory 610 and a communication unit 620. The memory 610 can be implemented using disc storage form as well as other forms of storage such as non-transitory storage devices including for example network memory devices, magnetic storage elements, magneto-optical storage elements, flash memory, core memory and/or other non-volatile storage technologies. Further, the communication unit 620 can be implemented using any one or a combination of a terrestrial broadcast transmitter, a cable broadcast transmitter, a satellite uplink transmitter, a network interface (e.g., WLAN card, Ethernet card, etc.), or the like.

The memory 610 is configured to store a TDO, which identifies a location of first content to be received by the reception apparatus 1 via a first communication interface (e.g., the network interface 70). The TDO is also associated with second content to be received by the reception apparatus via a second communication interface (e.g., the tuner interface 50). The communication unit 620 provides the TDO stored in the memory 610 to the reception apparatus 1. For example, the communication unit 1120 provides the TDO to the reception apparatus 1 via the TS or the Internet. As noted above, in one embodiment the TDO further defines a channel number to be associated with the first content in a virtual channel table stored in the reception apparatus.

The various processes discussed above need not be processed chronologically in the sequence depicted as flowcharts; the steps may also include those processed in parallel or individually (e.g., in paralleled or object-oriented fashion).

Also, the programs may be processed by a single computer or by a plurality of computers on a distributed basis. The programs may also be transferred to a remote computer or computers for execution.

Furthermore, in this specification, the term “system” means an aggregate of a plurality of component elements (apparatuses, modules (parts), etc.). All component elements may or may not be housed in a single enclosure. Therefore, a plurality of apparatuses each housed in a separate enclosure and connected via a network are considered a network, and a single apparatus formed by a plurality of modules housed in a single enclosure are also regarded as a system.

Also, it should be understood that this technology when embodied is not limited to the above-described embodiments and that various modifications, variations and alternatives may be made of this technology so far as they are within the spirit and scope thereof.

For example, this technology may be structured for cloud computing whereby a single function is shared and processed in collaboration among a plurality of apparatuses via a network.

Also, each of the steps explained in reference to the above-described flowcharts may be executed not only by a single apparatus but also by a plurality of apparatuses in a shared manner.

Furthermore, if one step includes a plurality of processes, these processes included in the step may be performed not only by a single apparatus but also by a plurality of apparatuses in a shared manner.

Numerous modifications and variations of the present invention are possible in light of the above teachings. It is therefore to be understood that within the scope of the appended claims, the invention may be practiced otherwise than as specifically described herein.

1. A method of a reception apparatus for accessing content from a plurality of content sources, comprising:
receiving a channel selection from a user;
determining, by the reception apparatus, a source of content associated with the selected channel based on at least one virtual channel table stored in a memory of the reception apparatus;
receiving first content via a first communication interface when the selected channel is determined to be associated with a first source; and
receiving second content via a second communication interface when the selected channel is determined to be associated with a second source.

2. The method according to claim 1, wherein
the first communication interface is a tuner interface configured receive content from at least one of a terrestrial, cable, and satellite broadcaster; and
the second communication interface is a network interface configured to access a data communication network.

3. The method according to claim 2, wherein
the data communication network is the Internet.

4. The method according to claim 1, wherein the step of receiving the first content comprises:
receiving the first content broadcast on a digital television broadcast channel.

5. The method according to claim 1, wherein the step of receiving the second content comprises:
receiving the second content via the Internet.

6. The method according to claim 1, wherein
the step of receiving the first content includes receiving the first content based on a first virtual channel table stored in the memory; and
the step of receiving the second content includes receiving the second content based on a second virtual channel table stored in the memory.

7. The method according to claim 1, further comprising:
receiving a triggered declarative object (TDO) that identifies a location of the second content; and
storing the location of the second content in the at least one virtual channel table in response to receiving a request from a user.

8. The method according to claim 7, wherein
the step of storing includes storing the location of the second content in association with a channel number identified by the TDO.

9. The method according to claim 1, further comprising:
accessing a website of available content on a data communication network; and
storing the location of the available content on the data communication network in the at least one virtual channel table, the location being received from the website.

10. The method according to claim 9, wherein
the step of storing includes storing the location of the available content in association with a channel number received from the website.

11. The method according to claim 1, wherein
the channel selection includes a channel number with a major and minor number; and
when the at least one virtual channel table stores information associated with the first source and the second source are associated with the same content provider, the first source and the second source are assigned the same major channel number.

12. A non-transitory computer-readable storage medium having embedded therein instructions which when executed by a computer, cause the computer to perform a method comprising:
receiving a channel selection from a user;
determining a content source associated with the selected channel based on at least one virtual channel table stored in a memory of the reception apparatus;
tuning to a broadcast channel when the selected channel is determined to be associated with broadcast content; and
accessing content via a data communication network when the selected channel is determined to be associated with content located on the data communication network.

13. A reception apparatus, comprising:
an input unit configured to receive a channel selection from a user;
a processor configured to
determine a source of content associated with the selected channel based on at least one virtual channel table stored in a memory of the reception apparatus;
control a first communication interface to receive first content when the selected channel is determined to be associated with a first source; and
control a second communication interface to receive second content when the selected channel is determined to be associated with a second source.

14. The reception apparatus according to claim 13, wherein
the first communication interface is a tuner interface configured receive content from at least one of a terrestrial, cable, and satellite broadcaster; and
the second communication interface is a network interface configured to access a data communication network.

15. The reception apparatus according to claim 14, wherein
the data communication network is the Internet.

16. The reception apparatus according to claim 13, wherein
the first content is broadcast on a digital television broadcast channel.

17. The reception apparatus according to claim 13, wherein
the second content is received via the Internet.

18. The reception apparatus according to claim 13, wherein the processor is configured to:
control the first communication interface to receive the first content based on a first virtual channel table stored in the memory; and
control the second communication interface to receive the second content based on a second virtual channel table stored in the memory.

19. The reception apparatus according to claim 13, wherein the processor is configured to:
receive a triggered declarative object (TDO) that identifies a location of the second content; and
store the location of the second content in the at least one virtual channel table in response to receiving a request from a user.

20. The reception apparatus according to claim 19, wherein
the processor stores the location of the second content in association with a channel number identified by the TDO.

21. The reception apparatus according to claim 13, wherein the processor is configured to:
access a website of available content on a data communication network; and
store the location of the available content on the data communication network in the at least one virtual channel table, the location being received from the website.

22. The reception apparatus according to claim 21, wherein
the processor is configured to store the location of the available content in association with a channel number received from the website.

23. The reception apparatus according to claim 13, wherein
the channel selection includes a channel number with a major and minor number; and
when the at least one virtual channel table stores information associated with the first source and the second source are associated with the same content provider, the first source and the second source are assigned the same major channel number.

24. An information providing apparatus, comprising:
a memory configured to store a triggered declarative object (TDO) that identifies a location of first content to be received by a reception apparatus via a first communication interface, the TDO being associated with second content to be received by the reception apparatus via a second communication interface; and
a communication unit configured to provide the TDO to the reception apparatus.

25. The information providing apparatus according to claim 24, wherein
the TDO defines a channel number to be associated with the first content in a virtual channel table stored in the reception apparatus.
